(19) United States
(12) Patent Application Publication
(10) Pub. No.: US 2012/0250340 A1
(43) Pub. Date: Oct. 4, 2012

(54) TAILLIGHT ANTITHEFT SYSTEM

(76) Inventor: Tony Nichols, Kansas City, KS (US)

(21) Appl. No.: 13/158,119

(22) Filed: Jun. 10, 2011

Related U.S. Application Data
(63) Continuation-in-part of application No. 13/074,411, filed on Mar. 29, 2011.

(51) Int. Cl. F21S 8/10; B23P 11/00; B60Q 1/30

(52) U.S. Cl. 362/485; 362/549; 29/428

(57) ABSTRACT

A taillight antitheft system having a frame with an interior void having a bar network and/or a screen configured to be permanently mounted over a grouping of LED taillight units and to an adjacent-mounting surface via a welding process. In this manner, system obstructs access to the LED taillight units, thereby preventing unauthorized removal or theft thereof, while permitting light emitted from the LED taillight units to pass therethrough, thereby not materially interfering with the underlying purpose of the LED taillight units. The system is only removable from the mounting surface via destroying weld marks produced during the welding process.

### CROSS-REFERENCE TO RELATED APPLICATION

This patent application claims priority to and is a continuation-in-part of U.S. patent application Ser. No. 13/074,411 filed Mar. 29, 2011, the entire contents of which is herein incorporated by reference in its entirety.

### BACKGROUND

1. Field of the Invention

The present inventive concept relates generally to an antitheft system for a light. More specifically, embodiments of the present inventive concept concern a light cover being particularly suitable for use as an antitheft system when the light cover is mounted to a taillight of a vehicle so as to prevent removal of the taillight or portions thereof.

2. Description of the Related Art

The advantages light emitting diodes (LEDs) relative to traditional light sources, (e.g., incandescent bulbs), are known. Principal advantages of LEDs over such traditional light sources include lower energy consumption, less occupied area, increased durability, and increased lifespan (e.g., approximately fifty thousand additional hours).

Until recently, a number of factors depressed the acceptance of LEDs as a replacement for traditional light sources. A principal cause of the depressed acceptance rate of LEDs included their high cost of manufacturing, which translated to a high purchase price. Thus, the use of LEDs in many applications was cost-prohibitive.

While the costs of manufacturing and purchasing LEDs have decreased and LEDs are being utilized in more applications, the purchase price is still high. Consequently, applications where LEDs are exposed and easily removed render such LEDs subject to unauthorized removal or theft. A common application of LEDs that is particularly subject to theft is as lighting for semitrailers; especially such lighting that is arranged in a cluster of LEDs such as LED taillights.

LED taillights on semitrailers are typically installed as integral units via screws that are in plain sight and an easily-severable electrical wire plugged into a rear of each unit. Thus, removal of LED taillights is a fairly easy and quick process. Additionally, given that semitrailers are often parked in desolate areas (e.g., large parking lots at truck stops or train yards), it is unlikely that an individual attempting to remove the LED taillights would be observed during the removal process and have its efforts thwarted.

In addition to the financial and time burdens required to replace LED taillights, theft of LED taillights is particularly problematic because an operator of the semitrailer may not immediately become aware of the theft and may continue to operate the semitrailer without LED taillights. Operating a semitrailer on a highway or other roadway is extremely hazardous, especially during conditions of impaired visibility (e.g., during the night-time or fog).

Presently, there is no readily-available system to prevent or even deter theft of LED taillights of semitrailers. In view of the aforementioned problems, there is a need for a taillight antitheft system that prevents unauthorized removal of LEDs, is easily and economically manufactured, easily installed, and does not materially interfere with the underlying purpose of the LEDs.

### SUMMARY

The following summary is provided to indicate the nature of the subject matter disclosed herein. While certain aspects of the present inventive concept are described below, the summary is not intended to limit the scope of the present inventive concept.

Embodiments of the present inventive concept provide a taillight antitheft system that remedies the problem of unauthorized LED removal, as set forth above, by simultaneously obstructing access to LEDs and permitting light emitted from the LEDs to at least partially pass therethough. As such, the present inventive concept prevents theft of the LEDs without materially interfering with the underlying purpose of the LEDs. Additionally, the present inventive concept is easily and economically manufactured and easily installed.

The present inventive concept provides, in its simplest form, a frame having an interior bar network and/or screen configured to be permanently mounted over a grouping of taillight units and to an adjacent-mounting surface via a welding process. In this manner, the frame is only removable from the mounting surface via destroying weld marks produced during the welding process.

The aforementioned aspects may be achieved in one aspect of the present inventive concept by providing a taillight anti-theft system including a frame defining a planar void on an interior thereof, the frame having an abutment surface operable to engage a surface adjacent to a taillight, and an interior assembly fixedly attached to the frame and spanning the void. The interior assembly may be operable to (i) permit transmission of light from the taillight at least partially therethrough, and (ii) prevent removal of at least a portion of the taillight. The interior assembly may define an open area along the void operable to permit the transmission of the light.

The open area may comprise one of (i) at least 50% of the void, (ii) at least 75% of the void, and (iii) at least 80% of the void. The interior assembly may a bar network and/or a screen. The bar network may include a plurality of bars each having a portion spaced from the frame defining the open area. The screen may include a plurality of apertures defining the open area. The frame may have a maximum outer dimension (Dmax) and a minimum outer dimension (Dmin) with a ratio Dmax:Dmin of at least 1.5:1. Dmax may be in a range of 12 to 20 inches and Dmin may be in a range of 4 to 8 inches. The frame may have a width that may be in a range of 0.1 to 1 inch.

The device may not include an element operable to permit selective attachment of the device. The frame may be (i) operable to be permanently attached to the surface adjacent to the taillight via a permanent-attachment process, and (ii) only removable from the surface adjacent to the taillight via destroying a product of the permanent-attachment process. The product of the permanent-attachment process may be a weld.

The device may include another planar void defined by the frame on the interior thereof. The another planar void may be oriented perpendicular to the void. The interior assembly may include a dogleg portion so that a portion of the interior assembly is operable to span the another planar void.

The aforementioned aspects may be achieved in another aspect of the present inventive concept by providing a method of preventing theft of a taillight. The method may include the steps of providing an obstruction assembly having (i) a perimeter member defining a planar void on an interior thereof, and (ii) a spanning member affixed to the perimeter member and extending across the void, the spanning member operable to permit transmission of light at least partially therethrough, and obstructing a portion of the taillight by affixing the obstruction assembly to a surface adjacent to the taillight. The spanning member may define an open area along the void to permit the transmission of the light, the open area comprising one of (i) at least 50% of the void, (ii) at least 75% of the void, and (iii) at least 80% of the void. The spanning member may be one of a bar network and/or a screen. The obstruction assembly may be permanently secured to the surface adjacent to the taillight. The step of securing the obstruction assembly to the surface adjacent to the taillight may include welding a portion of the obstruction assembly to the surface. The obstruction assembly may be only removable from the surface adjacent to the taillight via grinding.

The aforementioned aspects may be achieved in another aspect of the present inventive concept by providing a trailer for transporting goods having taillights and taillight covers to prevent theft of the taillights. The trailer may include a plurality of taillight groupings on an end of a trailer, and a cover affixed to a surface adjacent to each of the groupings and operable to (i) permit transmission of light from each of the groupings at least partially therethrough, and (ii) prevent removal of at least a portion of each of the groupings. The cover may include a frame defining a planar void on an interior thereof, and an interior structure spanning the void. The interior structure may define an open area along the void operable to permit the transmission of the light, the open area comprising one of (i) at least 50% of the void, (ii) at least 75% of the void, and (iii) at least 80% of the void. The interior structure may be one of a bar network and/or a screen. The cover may be (i) permanently affixed to the surface adjacent to each of the groupings via a permanent-attachment process, and (ii) only removable from the surface via destroying a product of the permanent-attachment process. The product of the permanent-attachment process may be a weld.

Other aspects and advantages of the present inventive concept will be apparent from the following detailed description of the preferred embodiments and the accompanying drawings figures.

### BRIEF DESCRIPTION OF THE FIGURES

Embodiments of the present inventive concept are described herein with reference to the following drawing figures, wherein:

FIG. 1 is a front left side perspective view of a taillight antitheft system in accordance with an exemplary embodiment of the present inventive concept illustrating the system in use with a trailer;

FIG. 2 is a magnified left side perspective view of the taillight antitheft system illustrated in FIG. 1;

FIG. 3 is a magnified, exploded right side perspective view of the taillight antitheft system illustrated in FIG. 1;

FIG. 4 is a magnified left side perspective view of a taillight antitheft system in accordance with a second embodiment of the present inventive concept;

FIG. 5 is a magnified, exploded right side perspective view of the taillight antitheft system illustrated in FIG. 4;

FIG. 6 is a magnified left side perspective view of a taillight antitheft system in accordance with a third embodiment of the present inventive concept; and

FIG. 7 is a magnified right side perspective view of a taillight antitheft system in accordance with a fourth embodiment of the present inventive concept.

### DETAILED DESCRIPTION

The present inventive concept is susceptible of embodiment in many forms. While the drawings illustrate, and the specification describes, certain embodiments of the invention, it is to be understood that such disclosure is by way of example only. The principles of the present inventive concept are not limited to the particular disclosed embodiments.

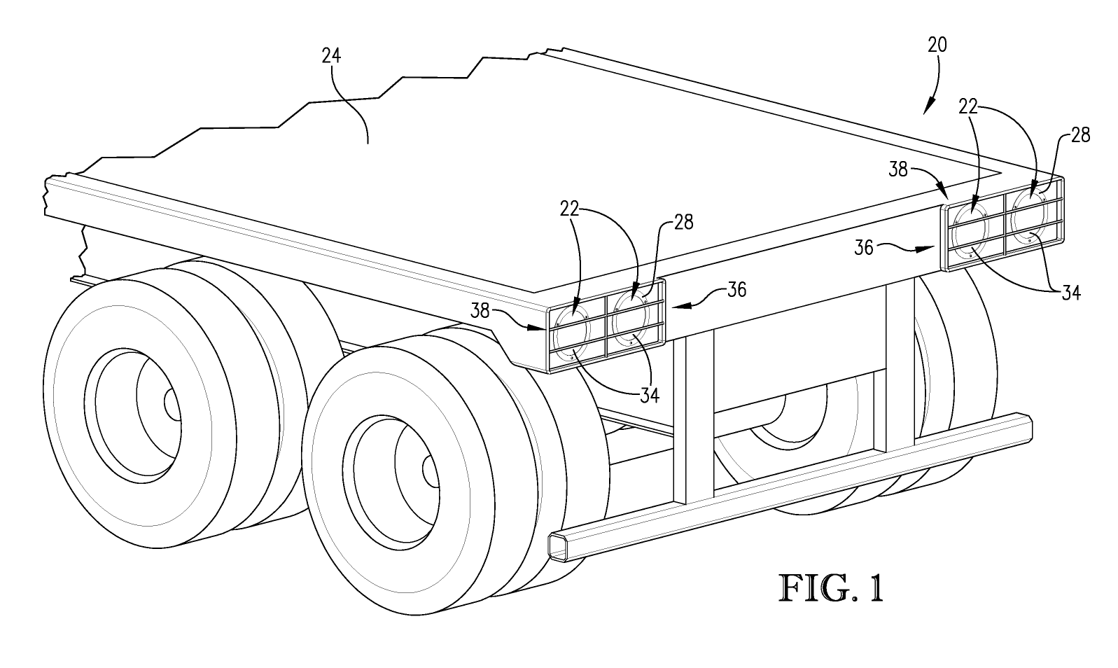

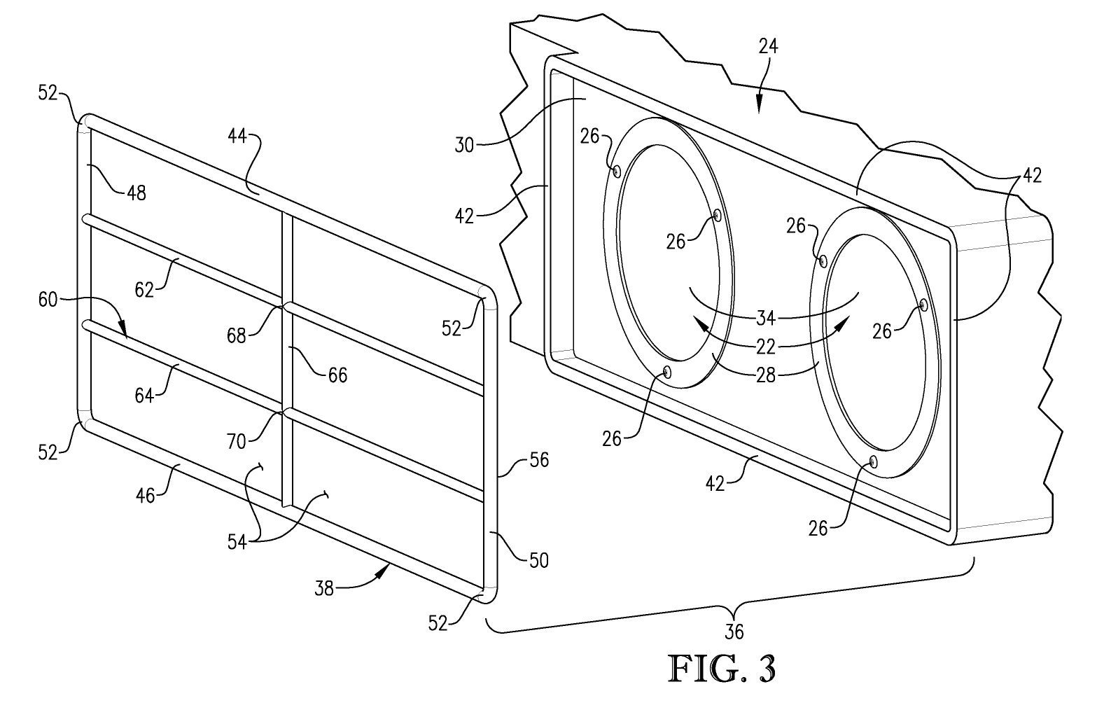

With initial reference to FIGS. 1-3, a taillight antitheft system 20 is generally illustrated in an exemplary embodiment in use with taillight units 22 of a trailer 24 to prevent or at least deter theft of the taillight units 22 or a component thereof. Each of the taillight units 22 are mounted in groupings of two on either side of the trailer 24 via a plurality of screws 26 that secure a circumferential taillight unit frame 28 of each of the taillight units 22 to a trailer support surface 30. Each of the taillight units 22 house at least one and preferably a cluster of light-emitting diodes (LEDs) 32 (e.g., fifteen LEDs).

The LEDs 32 are arranged in a configuration behind a lens 34 in an orientation that is operable to permit light emitted from the LEDs 32 to be transmitted through the lens 34. The LEDs 32 are electrically connected to a power source (not illustrated) of the trailer 24 (e.g., a battery of a vehicle connected to the trailer 24). In the exemplary embodiment, the lens 34 filters and focuses light emitted from the LEDs 32 to enable the taillight units 22 to be also utilized as brake lights and/or directional indicators for the trailer 24. Although the exemplary embodiment utilizes the taillight antitheft system 20 with taillight units 22 of the trailer 24, it is foreseen that the taillight antitheft system 20 may be utilized with any type of light and on any type of vehicle or trailer to prevent or at least deter theft of the light or component thereof without deviating from the scope of the present inventive concept. For example, applications of the taillight antitheft system 20 may include, but are not limited to, utilization with front, side, and/or rear lights of a vehicle and/or trailer.

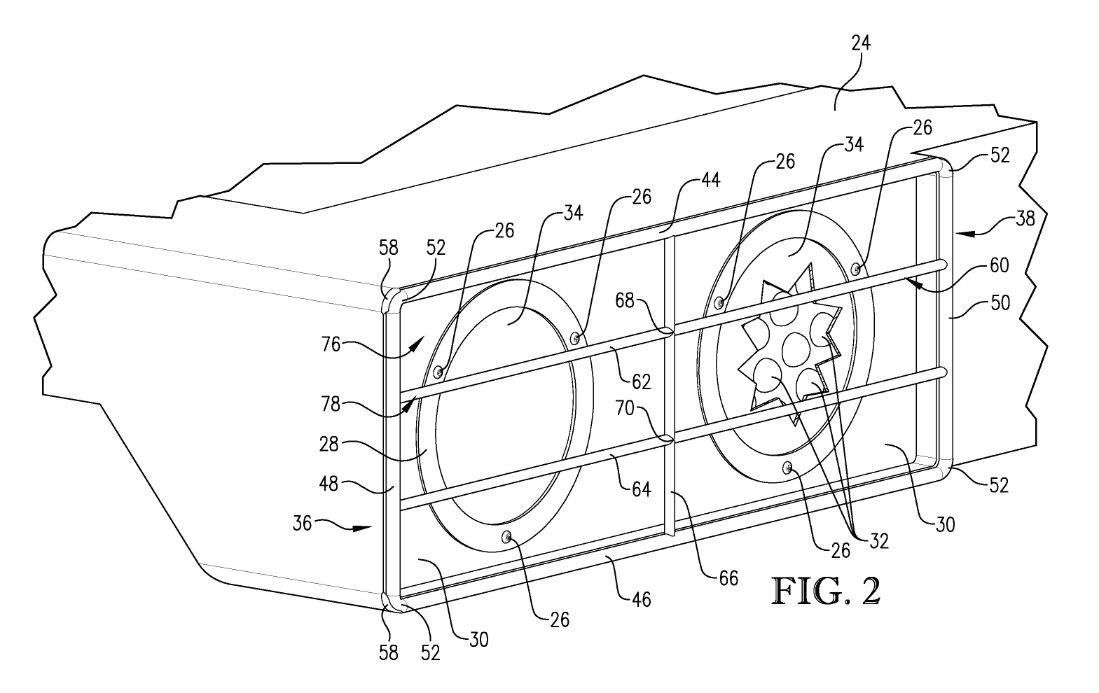

The taillight antitheft system 20 includes an assembly 36 having a perimeter frame structure 38 and/or a screen 40 that is mountable to a vertical surface 42 of the trailer 24, as illustrated in FIGS. 2, 4, and 6. The vertical surface 42 extends about a perimeter of each grouping of the taillight units 22 and is spaced therefrom by the trailer support surface 30, which secures the taillight units 22 to the trailer 24. The frame structure 38 is sized and shaped to be secured to the vertical surface 42 so that the assembly 36 completely covers each grouping of the taillight units 22. The frame structure 38 has upper and lower horizontal portions 44, 46, and left and right vertical portions 48, 50 that join at corners 52. In the exemplary embodiment, the frame structure 38 is formed by a single piece of bent wire having a diameter/width in the range of 0.1 to 1 inch, in the range of 0.15 to 0.5 inches, or about 0.25 inches. Each of the upper and lower horizontal portions 44, 46 have a length in the range of 12 to 20 inches, in the range of 14 to 18 inches, or about 16 inches. Each of the left and right vertical portions 48, 50 have a length in the range of 4 to 8 inches, in the range of 5 to 7 inches, or about 6 inches. Thus, the frame structure 38 can have a minimum dimension (Dmin) in the range of 4 to 8 inches, in the range of 5 to 7 inches, or about 6 inches, and a maximum dimension (Dmax) in the range of 12 to 20 inches, in the range of 14 to 18 inches, or about 16 inches. The frame structure 38 can have a Dmax:Dmin ratio of at least 1.5:1, at least 2:1, or at least 2.5:1 and not more than 8:1, not more than 4:1, or not more than 3:1. In this manner, the frame structure 38 is operable to extend over each grouping of the taillight units 22. It is foreseen that the frame structure 38 may be an assembly of independent wires of any length and diameter secured together at ends thereof, via welding or the like without deviating from the scope of the present invention.

The frame structure 38 defines a planar interior void 54 therein operable to permit light emitted from the LEDs 34 to be transmitted therethrough, and includes a perimeter abutment surface 56 on a rear thereof that is sized and shaped for abutting engagement with the vertical surface 42 of the trailer 24. The frame structure 38 does not have any screw-receiving apertures or other like element operable to permit selective attachment of the frame structure 38 to the vertical surface 42. Rather, the frame structure 38 is secured to the vertical surface 42 via a permanent-attachment process such as welding or the like. In the exemplary embodiment, each corner 52 of the frame structure 38 is attached to the vertical surface 42 via a welding, which produces a plurality of spot welds 58. In this manner, the frame structure 38 is only removable from the vertical surface 42 by destroying each of the plurality of spot welds 58 via grinding, sanding, or like obliteration process.

The frame structure 38 includes a bar network 60 operable to obstruct access to the taillight units 22. The bar network 60 includes upper and lower horizontally-extending bars 62, 64 and a vertically-extending bar 66 that span across the void 54 with ends of the bars 62, 64, 66 connected to the frame structure 38 via welding or the like. Additionally, the vertically-extending bar 66 may be connected to the horizontally-extending bars, 62, 64 at upper and lower intersections 68, 70 thereof via welding or the like to increase the structural integrity of the bar network 60. In the exemplary embodiment, the bar network 60 is formed using a plurality of wires of a 0.1875 inch diameter, the horizontally-extending bars 62, 64 are spaced two inches from each other and the vertical portions 48, 50 of the frame, and the vertically-extending bar 66 is spaced four inches from each of the horizontal portions 44, 46 (i.e., vertically centered in the frame structure 38). It is foreseen, however, that the bar network 60 may be an assembly of any number of horizontally-extending and/or vertically-extending wires of any length and diameter arranged in various configurations without deviating from the scope of the present invention.

The screen 40 is planar having a plurality of apertures 72 therethrough and an edge 74 about a perimeter of the screen 40. The screen 40 is mountable to the frame structure 38 via welding or the like, or may be sandwiched between the frame structure 38 and the vertical surface 42 during mounting of the frame structure 38 to the vertical surface 42 and then welded into place simultaneously with the frame structure 38 to the vertical surface 42, as previously discussed. In this manner, the screen 40 spans or extends across an entirety of the void 54.

Each of the bar network 60 and the screen 40 define, separately or in combination, a degree of open area 76 and a degree of closed area 78 in the void 54 of the frame structure 38. The degree of open area 76 is a percentage of area of the void 54 relative to the entire area of the void 54 that is free from obstruction and operable to expose the taillight units 22 so that light emitted therefrom may be transmitted through the taillight antitheft system 20. The degree of open area 76 is inverse to a degree of closed area 78 or percentage of area in the void 54 relative to the entire area of the void 54 that is obstructed and operable to conceal the taillight units 22 so that light emitted therefrom may not be transmitted through the taillight antitheft system 20 and theft of the taillight units 22 or components thereof (e.g., individual LEDs 32) is prevented.

The degree of open area 76 may be between 50% and 90% of the void 54, and the degree of closed area 78 may be between 10% and 50% of the void 54. The screen 40 defines the degrees of open and closed areas 76, 78 via the plurality of apertures 72 in the screen 40. Increasing a number of the apertures 72 and/or a size of the apertures 72 in the screen 40 causes the degree of open area 76 to be increased. The bar network 60 defines the degrees of open and closed areas 76, 78 via the bars 62, 64, 66. Increasing a number of one or more of the bars 62, 64, 66 and/or a size of the apertures bars 62, 64, 66 causes the degree of closed area 78 to be increased. It is foreseen that any number of apertures 72 could be utilized in the screen 40 to arrive at desired degrees of open and closed areas 76, 78. Likewise, it is foreseen that any number of bars 62, 64, 66 could be utilized in the bar network 60 to arrive at desired degrees of open and closed areas 76, 78.

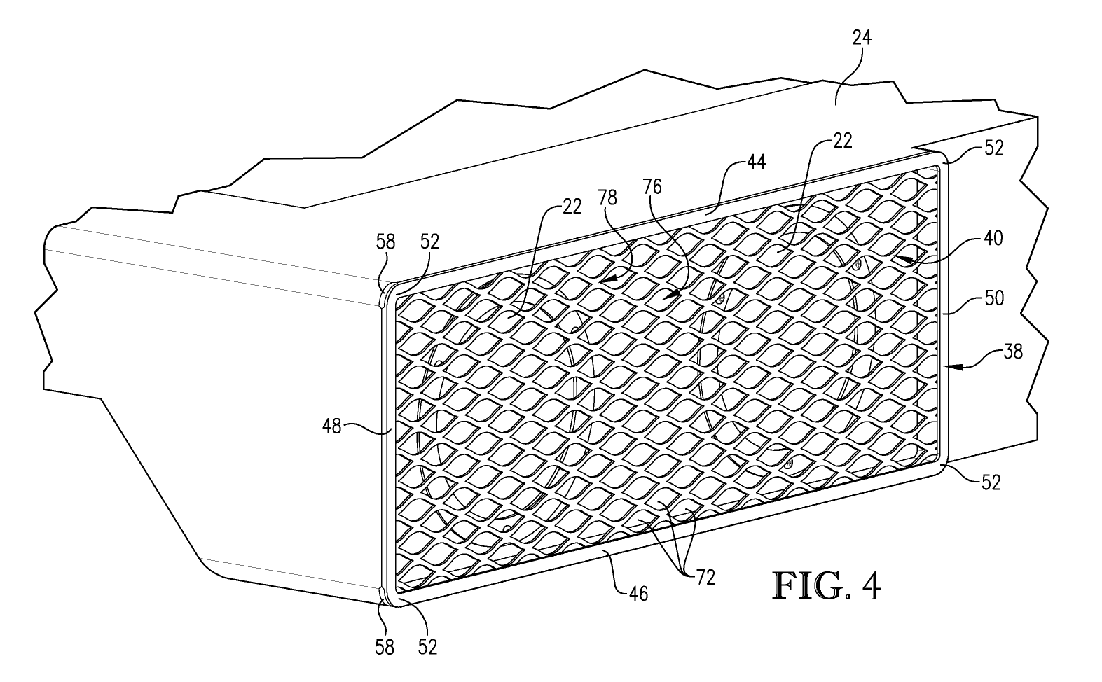

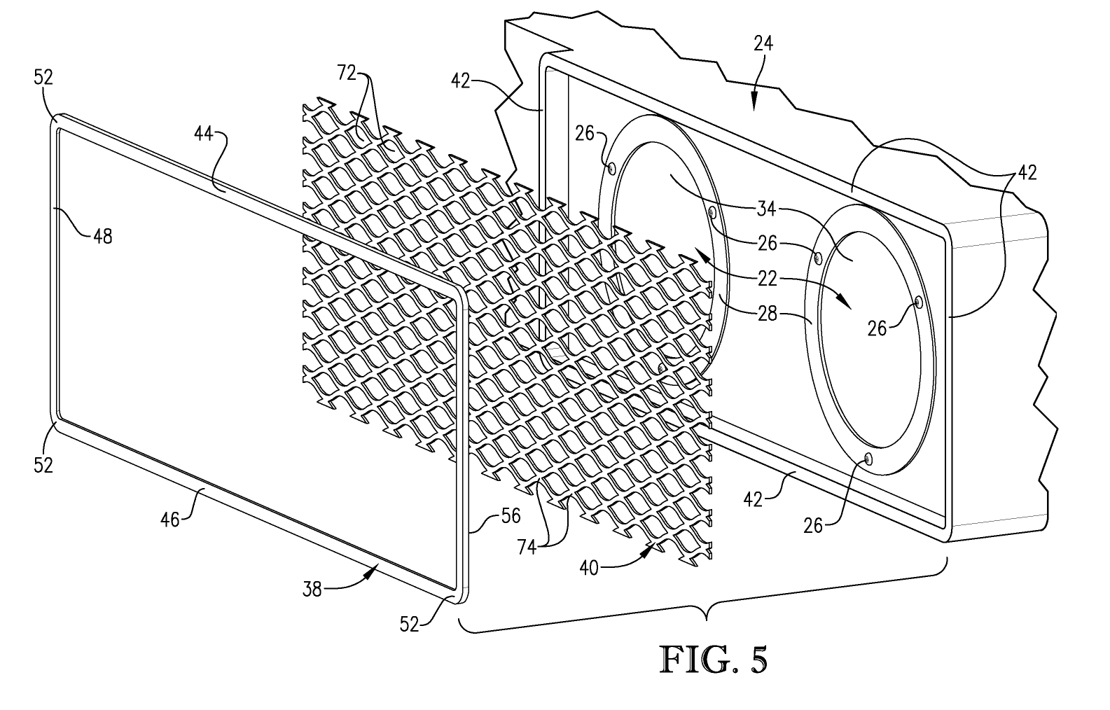

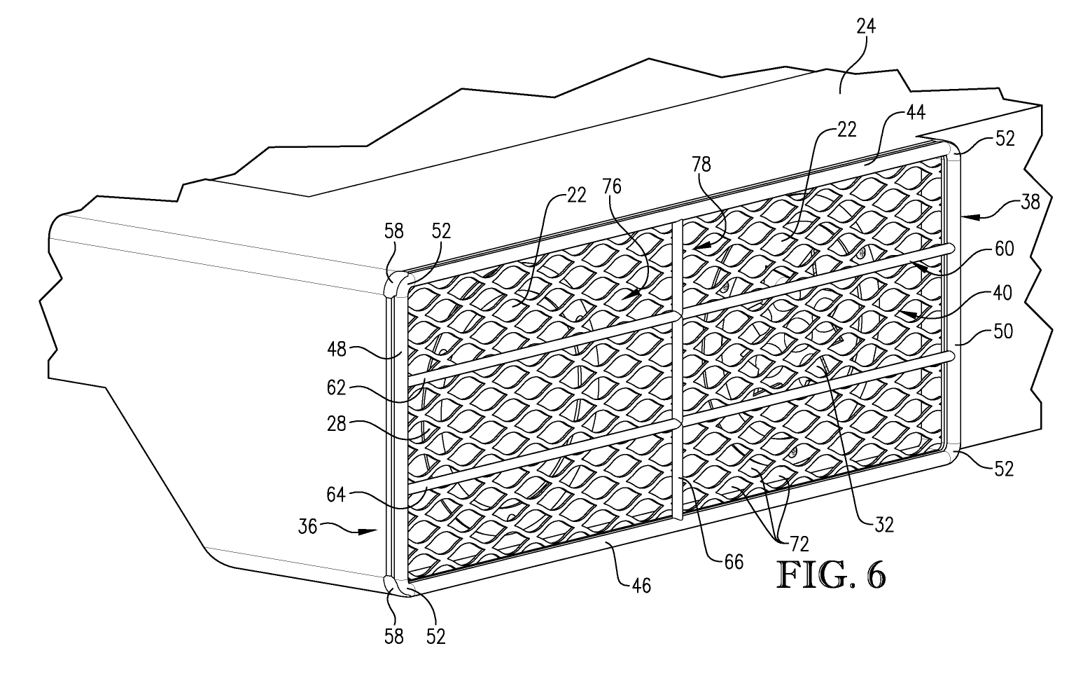

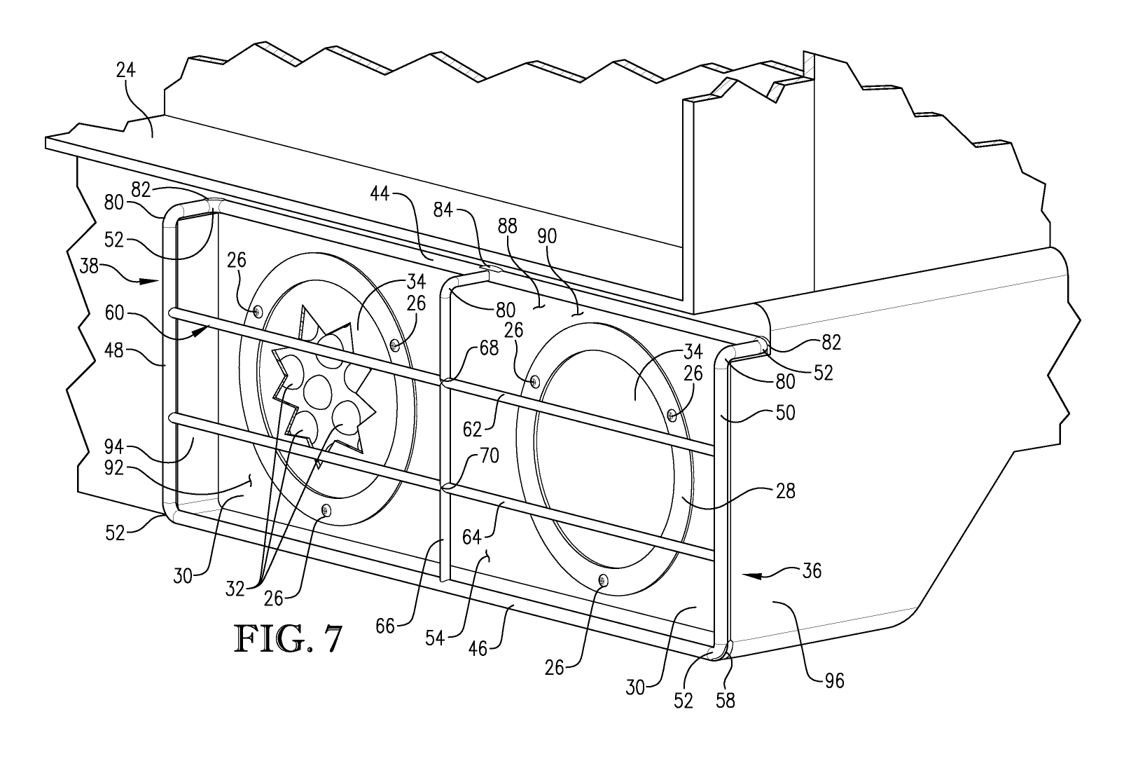

The bar network 60 and the screen 40 may be used by the taillight antitheft system 20 in various configurations and independently from each other. In the exemplary embodiment, the bar network 60 is used without a screen. In this embodiment, the bar network 60 defines the degree of open area 76 as approximately 80% and the degree of closed area 78 as approximately 20%. In a second embodiment, as illustrated by FIGS. 4 and 5, the screen 40 is used independent of a bar network. In this embodiment, the screen 40 defines the degree of open area 76 as approximately 75% and the degree of closed area 78 as approximately 25%. It is foreseen that the screen 40 may nest inside of the frame structure 38 so that the abutment surface 56 is operable to directly abut the vertical surface 42 of the trailer 24. In a third embodiment, as illustrated by FIG. 6, the bars 62, 64, 66 are used with the screen 40. In this embodiment, the bars 62, 64, 66 and screen 40 define the degree of open area 76 as approximately 70% and the degree of closed area 78 as approximately 30%. In a fourth embodiment, as illustrated by FIG. 7, each of the left and right vertical portions 48, 50 and the vertically-extending bar 66 include a ninety-degree bend or dogleg portion 80 at upper ends thereof so that the upper horizontal portion 44 is horizontally displaced from the planar interior void 54 defined by the frame structure 38. In this embodiment, a portion of the frame structure 38 is welded directly to the trailer 24 via spot welds 82 and a spot weld 84 placed at a junction 86 of the frame structure 38 and the trailer 24 adjacent to the vertically-extending bar 66. In this manner, a second planar interior void 88 oriented perpendicular to the planar interior void 54 is defined by the frame structure 38. Additionally, a horizontal gap 90 and a vertical gap 92 between left and right vertical surfaces 94, 96 of the trailer 24 are spanned by the frame structure 38. The horizontal gap 90 is oriented perpendicular to the vertical gap 92. In this manner, the taillight antitheft system 20 is operable to obstruct access to the taillight units 22 thereby preventing unauthorized removal (e.g., theft) of the taillight units 22 from the trailer 24. Thus, the present inventive concept provides a taillight antitheft system that prevents theft of LEDs without materially interfering with the underlying purpose of the LEDs, is easily and economically manufactured, and is easily installed.

The preferred forms of the invention described above are to be used as illustration only, and should not be used in a limiting sense to interpret the scope of the present inventive concept. Modifications to the exemplary embodiments, set forth above, could be readily made by those skilled in the art without departing from the spirit of the present inventive concept.

The inventors hereby state their intent to rely on the Doctrine of Equivalents to determine and assess the reasonably fair scope of the present inventive concept as it pertains to any apparatus not materially departing from but outside the literal scope of the invention as set forth in the following claims.

What is claimed is:

1. A taillight anti-theft system comprising:
a frame defining a planar void on an interior thereof, the frame having an abutment surface operable to engage a surface adjacent to a taillight; and
an interior assembly fixedly attached to the frame and spanning the void, the interior assembly operable to (i) permit transmission of light from the taillight at least partially therethrough, and (ii) prevent removal of at least a portion of the taillight.

2. The taillight anti-theft system of claim 1, wherein the interior assembly defines an open area along the void operable to permit the transmission of the light, the open area comprising at least 50% of the void.

3. The taillight anti-theft system of claim 2, wherein the interior assembly comprising a bar network and/or a screen.

4. The taillight anti-theft system of claim 2, wherein the interior assembly comprises a bar network including a plurality of bars each having a portion spaced from the frame defining the open area.

5. The taillight anti-theft system of claim 2, wherein the interior assembly comprises a screen including a plurality of apertures defining the open area.

6. The taillight anti-theft system of claim 1, wherein the frame has a maximum outer dimension (Dmax) and a minimum outer dimension (Dmin), and wherein the ratio Dmax:Dmin is at least 1.5:1.

7. The taillight anti-theft system of claim 6, wherein Dmax is in a range of 12 to 20 inches and Dmin is in a range of 4 to 8 inches.

8. The taillight anti-theft system of claim 7, wherein the frame has a width in the range of 0.1 to 1 inch.

9. The taillight anti-theft system of claim 1, wherein the device does not include an element operable to permit selective attachment of the device.

10. The taillight anti-theft system of claim 1, wherein the frame is (i) operable to be permanently attached to the surface adjacent to the taillight via a permanent-attachment process, and (ii) only removable from the surface adjacent to the taillight via destroying a product of the permanent-attachment process.

11. A method of preventing theft of a taillight, the method comprising the steps of:
providing an obstruction assembly having (i) a perimeter member defining a planar void on an interior thereof, and (ii) a spanning member affixed to the perimeter member and extending across the void, the spanning member operable to permit transmission of light at least partially therethrough; and
obstructing a portion of the taillight by affixing the obstruction assembly to a surface adjacent to the taillight.

12. The method of claim 11, wherein the spanning member defines an open area along the void to permit the transmission of the light, the open area comprising at least 50% of the void.

13. The method of claim 12, wherein the spanning member is one of a bar network and/or a screen.

14. The method of claim 11, wherein the obstruction assembly is permanently secured to the surface adjacent to the taillight.

15. The method of claim 14, wherein the step of securing the obstruction assembly to the surface adjacent to the taillight includes welding a portion of the obstruction assembly to the surface.

16. The method of claim 14, wherein the obstruction assembly is only removable from the surface adjacent to the taillight via grinding.

17. A trailer for transporting goods having taillights and taillight covers to prevent theft of the taillights, the trailer comprising:
a plurality of taillight groupings on an end of a trailer; and
a cover affixed to a surface adjacent to each of the groupings and operable to (i) permit transmission of light from each of the groupings at least partially therethrough, and (ii) prevent removal of at least a portion of each of the groupings,
wherein the cover includes a frame defining a planar void on an interior thereof, and an interior structure spanning the void.

18. The trailer of claim 17, wherein the interior structure defines an open area along the void operable to permit the transmission of the light, the open area comprising at least 50% of the void.

19. The trailer of claim 18, wherein the interior structure is one a bar network and/or a screen.

20. The trailer of claim 17, wherein the cover is (i) permanently affixed to the surface adjacent to each of the groupings via a permanent-attachment process, and (ii) only removable from the surface via destroying a product of the permanent-attachment process.

21. The taillight anti-theft system of claim 1, and
another planar void defined by the frame on the interior thereof, the another planar void oriented perpendicular to the void.

22. The taillight anti-theft system of claim 21, wherein the interior assembly includes a dogleg portion so that a portion of the interior assembly is operable to span the another planar void.
